(19) United States
(12) Patent Application Publication
(10) Pub. No.: US 2011/0071691 A1
(43) Pub. Date: Mar. 24, 2011

(54) INDUSTRIAL DEVICE CONTROLLED THROUGH A POWER OVER ETHERNET SYSTEM

(76) Inventor: Pierre Jean BERGERON, Hooksett, NH (US)

(21) Appl. No.: 12/881,726

(22) Filed: Sep. 14, 2010

Related U.S. Application Data
(60) Provisional application No. 61/243,631, filed on Sep. 18, 2009.

(51) Int. Cl. G06F 1/26

(52) U.S. Cl. 700/286; 713/300

(57) ABSTRACT

An industrial device and system for controlling and powering an industrial process mechanism through an Ethernet system, including an industrial process mechanism and a device controller including an Ethernet receiving circuit, a control processor and actuator connected from the Ethernet circuit, and an actuator including a low power drive mechanism and a force multiplication mechanism driving the industrial process mechanism.

### FIELD OF THE INVENTION

The present invention relates to an industrial device and industrial device actuator for use in an industrial process or system and, in particular, for an industrial device and industrial device actuator controlled through a power over Ethernet system.

### BACKGROUND OF THE INVENTION

Ethernet systems have long been well known to those of ordinary skill in the data communications arts as one of the most common and widely used system for communication all forms of data between digital devices, such computers. In the original Ethernet systems all of the computers in a system were connected to a single transmission line, such as a coaxial cable, and each computer in turn transmitted data packets to receiving computers. Access to the transmission line by the computers was controlled by any of a wide variety of access protocols and all packets were transmitted to all of the computers on the line, with each computer capturing those packets addressed to it by means of an address residing in each of the packets.

Ethernet systems have since expanding in power, complexity and speed and an Ethernet system may now be comprised of multiple networks arranged in a variety of configurations and interconnected through devices and sub-systems such as repeaters, bridges, routers, hubs and switches so that data packets may be routed to only a designated receiver or small group of receivers. In a like manner, the transmission lines now include, for example, twisted and shielded pairs, multiple conductor cables, fiber optic cables, radio and satellite links, and so forth, the devices have expanded to include such relatively small and low power devices as cameras, cell phones, printers, storage devices, and so forth.

Despite radical changes and advances in Ethernet net hardware and devices, however, Ethernet has retained the same standardized, uniform data formats and protocols so that any Ethernet system can communicate with any new, present or previously existing system.

A more recent development of Ethernet systems is “power over Ethernet”, also referred to by the abbreviation “PoE”, which is the transmission of limited amounts of power over standard multi-conductor Ethernet cables with DC power being carried either on conductors designated for DC power transmission, with other conductors being designated for data, or with the DC power being carried on the same conductors as data, with the data being separated from the DC power at the receiving end by transformers or other DC/AC separation circuits.

PoE networks offer significant advantages over systems employing separate data communication and power transmission systems, such as less cost because a PoE system requires only a single, lighter transmission line for both power and data while a conventional system requires a data line and a heavy power line and because the installation of PoE cabling does not require qualified or licensed technicians electricians. In addition, PoE networks may be used where, for example, time, space or cost constraints prohibit or limit the use or value of conventional AC power systems, such as temporary installations or installations in existing structures.

At present, however, and although PoE networks can carry more power than Universal Serial Bus (USB) systems, which is a short range data bus communication standard used primarily by computers and peripheral devices, PoE systems have been used only for lower power, computer related devices such as telephones, wireless LAN (local area network) systems, camera systems, small Ethernet switches, “thin” clients, LCD (liquid crystal display) and laser diode devices and MIDI (musical instrument digital interface) devices.

There are a number of applications, however, where the benefits of PoE networks would provide all of the advantages discussed above, but where PoE networks are not used because the power requirements of the devices to be controlled or monitored typically exceed the power available through PoE networks. Such applications typically include various forms of industrial systems involving, for example, the remote control of valves, pumps and other devices used to control and regulate various industrial processes and, because of their power requirements, may controlled through a network such as Ethernet but are powered by separate AC power lines.

The present invention provides a solution to these and related problems of the prior art.

### SUMMARY OF THE INVENTION

Wherefore, it is an object of the present invention to overcome the above mentioned shortcomings and drawbacks associated with the prior art.

The present invention is directed to an industrial device controlled and powered through a power over Ethernet system and an Ethernet system for controlling and powering an industrial process mechanism wherein the industrial device includes an industrial process mechanism and a device controller. The device controller includes a control processor connected from a data output and a power output of a power over Ethernet receiving circuit for receiving data including control instructions from the Ethernet and generating corresponding actuator control commands and an actuator connected from the power output over Ethernet receiving circuit and responsive to the actuator control commands for controlling operation of the industrial process a power level less than or equal to a power level defined by an industry standard for a power over internet system and a force multiplication mechanism driving the industrial process mechanism.

A system for controlling and powering an industrial process mechanism through an Ethernet system includes an Ethernet system communicating at least data including control instructions between a system controller and a device controller for controlling the industrial process mechanism, one of an endspan and a midspan for communicating data between the device controller and providing power to the device controller through an Ethernet transmission line, and the device controller. The device controller includes a power over Ethernet receiving circuit for receiving data and power from the one of the endspan and the midspan and for transmitting data to the one of the endspan and the midspan, a control processor connected from a data output and a power output of a power over the Ethernet receiving circuit for receiving data including control instructions from the Ethernet and generating corresponding actuator control commands, and an actuator connected from the power output over Ethernet receiving circuit and responsive to the actuator control commands for controlling operation of the industrial process mechanism wherein the actuator includes a low power drive mechanism requiring less than a power level defined and limited by the Ethernet connection, such as the 12 watts defined in the industry standard for a currently common version of the Ethernet or 25 watts defined in a pending new version of the industry standard, and a force multiplication mechanism driving the industrial process mechanism.

The low power drive mechanism may be a rotational driver or a linear driver comprised of either an electric motor or a hydraulic device, the force multiplication mechanism may be a gear train, a rack and pinion mechanism, a lever mechanism or a hydraulic mechanism, and the industrial process mechanism may be a valve, a pump, a motor or an actuator for a subsequent industrial process mechanism.

### BRIEF DESCRIPTION OF THE DRAWINGS

The invention will now be described, by way of example, with reference to the accompanying drawings in which:

FIG. 1 is a diagrammatic illustration of an exemplary industrial power over Ethernet system for controlling and powering a controlled device for controlling an industrial process mechanism;

FIGS. 2A and 2B are schematic illustrations of power over Ethernet transmission circuits;

FIG. 2C is a schematic representation of a power over Ethernet receiving circuit;

FIG. 3 is a diagrammatic illustration of a controlled device; and,

FIG. 4 is an isometric representation of a controlled device.

### DETAILED DESCRIPTION OF THE PREFERRED EMBODIMENTS

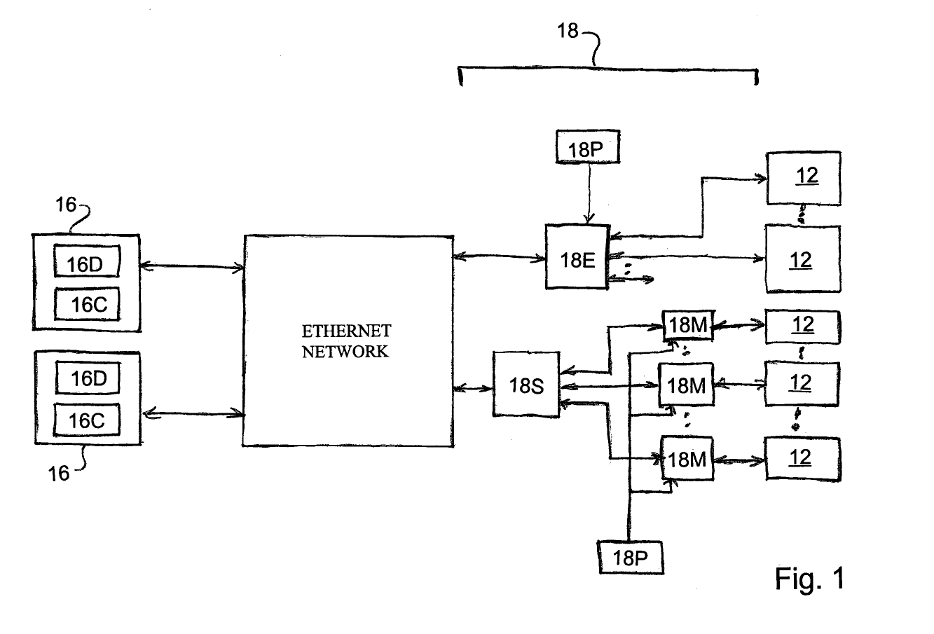

Referring to FIG. 1, therein is shown a diagrammatic representation of an exemplary industrial PoE system 10 according to the present invention. As illustrated therein, an industrial PoE system 10 includes one or more controlled devices 12 such as, for example, valves, pumps, actuators and other devices for controlling and regulating various industrial processes, and an Ethernet network 14 for communicating data, such as control commands and monitoring information, between one or more system controllers 16 and controlled devices 12. It is to be understood that network 14 may be comprised of any configuration or arrangement of a network or networks, including local and wide area networks or sub-systems of any configuration using any form of transmission line or connection, including, for example, coaxial cables, twisted and shielded pairs, multiple conductor cables, fiber optic cables, radio and satellite links, and including any number and configuration or arrangement of sub-systems, repeaters, bridges, routers, hubs and switches.

In a PoE system, such as the PoE system 10 illustrated in FIG. 1, the last segments or “spans” 18 of network 14 connecting the controlled devices 12 to the remainder of Ethernet network 14 and thus eventually to system controllers 16 are comprised of PoE spans 18, that is, are comprised of Ethernet transmission lines carrying both data and power. As shown in FIG. 1, the end of each PoE span 18 interfacing with Ethernet network 14 is comprised of either an “endspan” 18E or a “midspan” 18M which is interposed into the PoE span 18 between an Ethernet switch 18S, which in turn interfaces to Ethernet network 14, and the controlled device or devices 12.

Endspans 18E and midspans 18M both perform the function of combining the data from Ethernet network 14 with DC power from a power source 18P to deliver the DC power and data to the controlled device or devices 12 through the PoE span 18. Endspans 18E, however, are Ethernet PoE switches including PoE circuitry for combining DC power with the data to be transmitted to the controlled device or devices 12 is performed within the switch. Midspans 18M, in turn, are “power injectors” inserted between conventional Ethernet switches, that is, Ethernet switches not having the capability to combining the DC power with the data stream for transmission to the controlled device or devices 12, and contain PoE circuitry for combining DC power with the data to be transmitted to the controlled device or devices 12. Endspans 18E are typically used, for example, in new installations, while midspans 18M are typically used in existing installations to add PoE capability without the need to replace and configure a new Ethernet switch. Endspans 18E, however, may be added to existing installations in replacement of existing switches while midspans 18M may be used in new installations for various reasons, such as providing a temporary PoE capability or where endspans 18E are not available or are not practical.

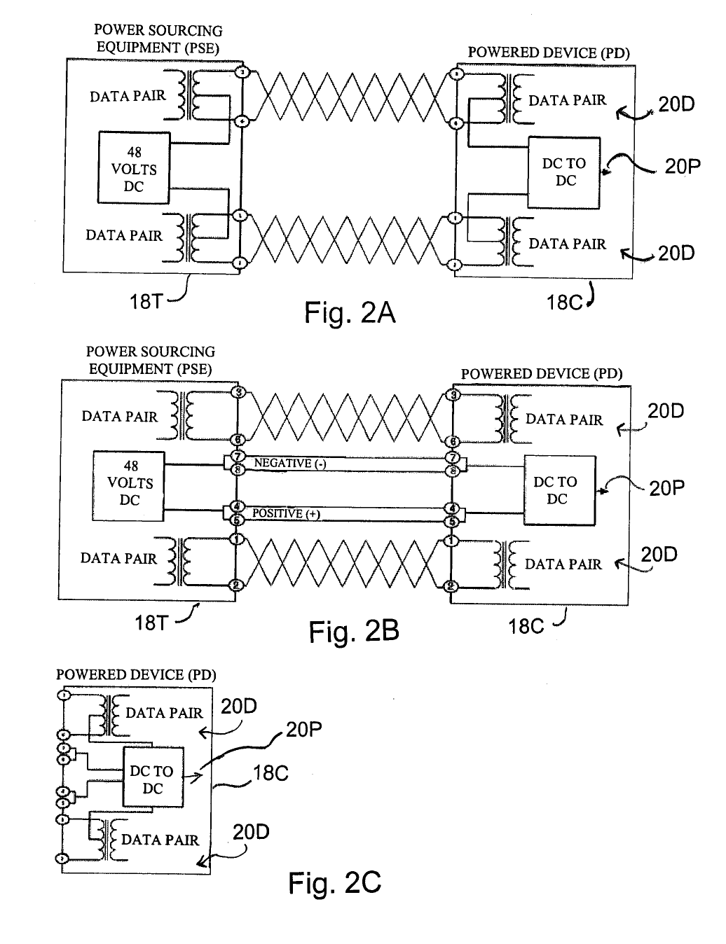

Lastly with respect to endspans 18E and midspans 18M, it should be noted that there are presently two standard methods for delivering DC power and data from an endspan 18E or midspan 18M to a controlled device or devices 12. In the first method, illustrated in FIG. 2A, a PoE transmission circuit 18T in the endspan 18R or midspan 18M combines the DC power onto the same transmission lines or conductors for transmission tot he controlled device or devices 12. In the alternative method, illustrated in FIG. 2B, the PoE transmission circuit 18T in the endspan 18E or midspan 18M transmits the data to the controlled device or devices 12 on one set of transmission lines or conductors and the DC power to the controlled device of devices 12 on another set of transmission lines or conductors. A controlled device 12 will correspondingly include a PoE receiving circuit 18C as illustrated in FIG. 2C for receiving and separating the DC power and data signals, with a PoE receiving circuit 18C being typically designed to operate with both methods for delivering the DC power and data.

It must also be noted that a PoE receiving circuit 18C also transmits data from the controlled device 12 to the PoE transmission circuit 18T and that a PoE transmitting circuit 18T, in addition to transmitting power and data to a PoE receiving circuit 18C receives data from a PoE receiving circuit 18C and transmits the data onto the Ethernet network 14.

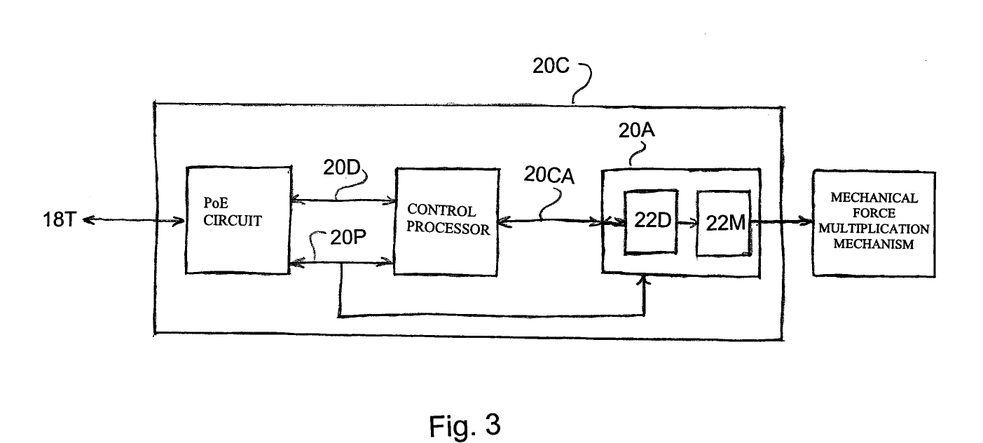

Referring to FIG. 3, therein is a diagrammatic illustration of a controlled device 12 of the present invention that is controlled and powered through a PoE span 18 of an Ethernet network 14. As shown therein, a controlled device 12 includes an industrial process mechanism 20M for controlling, monitoring or regulating an industrial processes, such as a valve, pump, motor or linear or rotational actuator and a device controller 20C that includes a PoE circuit 18C for receiving and separating DC power and data received from and endspan 18E or midspan 18M.

Device controller 20C will also include a control processor 12P connected from data output 20D and power output 20P of PoE circuit 18C and will interpret commands received through data output 20D from the data transmitted to the controlled device 12 to in turn provide actuator control command outputs 20CA to an actuator 20A, which also receives DC power from power output 20P of PoE circuit 18C. Actuator 20A will in turn control and actuate the industrial process mechanism 20M and will monitor the state of industrial process mechanism 20M to provide corresponding mechanism state outputs 20MS to control processor 12C, which will in turn transmit data representing mechanism state outputs 20MS through the PoE span 18 and network 14 to the system controller or controllers 16.

According to the present invention, actuator 20A is a rotational or linear actuation device including a low power drive mechanism 22D requiring less than the 12 watts defined in a currently adopted PoE standard or the 25 watts defined in a pending PoE standard or as otherwise defined by PoE standards. The drive mechanism may include such elements as a rotational or linear electric motor or hydraulic motor or piston, and mechanical force multiplication mechanism 22M, such as an a gear train, rack and pinion mechanism, lever mechanism or hydraulic piston mechanism, providing a force multiplication sufficient to allow a drive mechanism 22D to drive the actuation of an industrial process mechanism 20M. The force multiplication mechanism 22M may thereby trade speed of actuation for actuating force or, in alternate embodiments, the industrial process mechanism 20M may be of a design requiring relatively little actuating force, such as a Teflon seal and bearing ball valve, or may be a low power actuator for a subsequent industrial process mechanism, such as a hydraulic control valve controlling a hydraulic pressure that in turn controls a significantly larger mechanism.

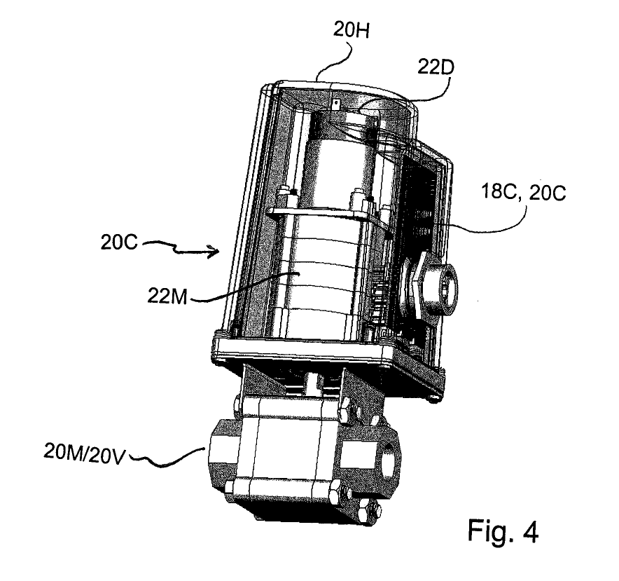

An exploded view of an exemplary controlled device 12 of the present invention is illustrated in FIG. 4 wherein, as shown, the industrial process mechanism 20M is comprised of a rotary ball valve 20V and the device controller 20C is constructed as a single assembly with the ball valve, being contained in a controller housing 20H mounted onto the ball valve mechanism. In this exemplary embodiment the low power drive mechanism 22D is comprised of an electric motor, the force multiplication mechanism 20M is comprised of a gear train and the control processor 12P and PoE circuit 18C reside on circuit boards within the controller housing 20H.

It should also be noted that a user interface at a system controller 16 for the input of control commands for an industrial process mechanism 20M and the display of state outputs 20MS representing the operating state of the industrial process mechanism 20M may be implemented in a number of ways. For example, a system controller 16 will typically include a display 16D and a control input mechanism 16C, such as a keyboard, mouse or touch screen display implemented on display 16D. In one implementation, and for example, the system controller 16 may store a graphical interface representation of control inputs, such as open/close or on/off buttons and control displays, such as representations of the operating state of a industrial process mechanism 20M to generate control inputs to the transmitted as data to the controlled device 12 and to display the state outputs 20MS transmitted as data from the controlled device 12. In another example, the controller processor 12C or an associated memory in the controlled device 12 may store the general equivalent of the above discussed graphical interface representation of control inputs and outputs in, for example, the form of a hypertext markup language page 12P, that is, a web page, or equivalent, to be transmitted to and displayed at a system controller 16 as discussed above, thereby allowing any system controller 16 having network 14 access to the controlled device 12 to control the controlled device 12.

Since certain changes may be made in the above described system and method for control of industrial process mechanisms through PoE Ethernet systems without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An industrial device controlled and powered through a power over Ethernet system, comprising:
an industrial process mechanism, and
a device controller, including
a control processor connected from a data output and a power output of a power over Ethernet receiving circuit for receiving data including control instructions from the Ethernet and generating corresponding actuator control commands, and
an actuator connected from the power output over Ethernet receiving circuit and responsive to the actuator control commands for controlling operation of the industrial process mechanism, and including
a low power drive mechanism requiring a power level less than or equal to a power level defined by an industry standard for a power over internet system, and
a force multiplication mechanism driving the industrial process mechanism.

2. The industrial device controlled and powered through a power over Ethernet system of claim 1 wherein the lower power drive mechanism is one of a rotational driver and a linear driver.

3. The industrial device controlled and powered through a power over Ethernet system of claim 1 wherein the lower power drive mechanism is one of an electric motor and a hydraulic device.

4. The industrial device controlled and powered through a power over Ethernet system of claim 1 wherein the force multiplication mechanism is one of a gear train, a rack and pinion mechanism, a lever mechanism and a hydraulic mechanism.

5. The industrial device controlled and powered through a power over Ethernet system of claim 1 wherein the industrial process mechanism is one of a valve, a pump, a motor and an actuator for a subsequent industrial process mechanism.

6. A system for controlling and powering an industrial process mechanism through an Ethernet system, comprising:
an Ethernet system communicating at least data including control instructions between a system controller and a device controller for controlling the industrial process mechanism,
one of an endspan and a midspan for communicating data between the device controller and providing power to the device controller through an Ethernet transmission line, and
the device controller, including
a power over Ethernet receiving circuit for receiving data and power from the one of the endspan and the midspan and for transmitting data to the one of the endspan and the midspan,
a control processor connected from a data output and a power output of a power over the Ethernet receiving circuit for receiving data including control instructions from the Ethernet and generating corresponding actuator control commands, and
an actuator connected from the power output over Ethernet receiving circuit and responsive to the actuator control commands for controlling operation of the industrial process mechanism, the actuator including
a low power drive mechanism requiring a power level less than or equal to a power level defined by an industry standard for a power over internet system, and
a force multiplication mechanism driving the industrial process mechanism.

7. The industrial device controlled and powered through a power over Ethernet system of claim 6 wherein the lower power drive mechanism is one of a rotational driver and a linear driver.

8. The industrial device controlled and powered through a power over Ethernet system of claim 6 wherein the lower power drive mechanism is one of an electric motor and a hydraulic device.

9. The industrial device controlled and powered through a power over Ethernet system of claim 6 wherein the force multiplication mechanism is one of a gear train, a rack and pinion mechanism, a lever mechanism and a hydraulic mechanism.

10. The industrial device controlled and powered through a power over Ethernet system of claim 6 wherein the industrial process mechanism is one of a valve, a pump, a motor and an actuator for a subsequent industrial process mechanism.
